(19) United States
(12) Patent Application Publication
(10) Pub. No.: US 2022/0207625 A1
(43) Pub. Date: Jun. 30, 2022

(54) CONTROL METHOD, INFORMATION PROCESSING DEVICE, INFORMATION PROCESSING SYSTEM, AND CONTROL PROGRAM

(71) Applicant: FUJITSU LIMITED, Kawasaki-shi (JP)

(72) Inventor: Fumihiko Kozakura, Hachioji (JP)

(73) Assignee: FUJITSU LIMITED, Kawasaki-shi (JP)

(21) Appl. No.: 17/696,213

(22) Filed: Mar. 16, 2022

Related U.S. Application Data
(63) Continuation of application No. PCT/JP2019/039109, filed on Oct. 3, 2019.

(51) Int. Cl. G06Q 50/06

(52) U.S. Cl. CPC G06Q 50/06

(57) ABSTRACT

A control method executed on a computer controls a transaction of electric power between a first consumer and a second consumer different from the first consumer, wherein the first consumer and the second consumer receives a request for electric power saving from an aggregator. The method includes obtaining a first amount of electric power as an amount of electric power to be purchased by the first consumer; obtaining a second amount of electric power that can be sold by the second consumer; and controlling the transaction of electric power between the first and second consumers, even when the second amount is greater than or equal to the first amount, according to a comparison result between a predicted value of shortage of electric power with respect to a target of electric power saving, and a measured value of the shortage of electric power at the first consumer.

### CROSS-REFERENCE TO RELATED APPLICATIONS

This application is a continuation application of International Application PCT/JP2019/039109 filed on Oct. 3, 2019, and designated the U.S., the entire contents of which are incorporated herein by reference.

### FIELD

The present disclosure relates to a control method, an information processing device, an information processing system, and a control program.

### BACKGROUND

When supply of electric power becomes tight, by making a request for electric power saving to consumers, DR (Demand Response) transactions are executed to prevent the electric power grid from going down. In such DR transactions, when an electric power company makes a request for electric power saving to an aggregator, the aggregator makes a request for electric power saving for each consumer. In response the request for electric power saving from the aggregator, each consumer replies with whether the target of electric power saving can be achieved by the time limit of DR response. A consumer who received the request for electric power saving shuts down devices including air conditioners and the like as measures of achieving the target of electric power saving, and also operates the private electric power generator to realize apparent power saving.

The monetary reward of the DR transactions is received by the aggregator all together, and then, the aggregator distributes the reward to the respective consumers. As the monetary reward is large, it is advantageous for the consumers to participate in the DR transactions; however, the reward may not be received at all if the target of electric power saving is missed even by a narrow margin.

Therefore, even in the case where a consumer who received a DR transaction fails in achieving the target of electric power saving, P2P electric power transactions are considered promising to make the target of electric power saving achievable, in which the shortage is accommodated with the other consumers.

FIG. 1 is a diagram illustrating an example in which shortage with respect to a request for electric power saving is accommodated by P2P electric power transactions. In FIG. 1, consumers A and C who received a request for electric power saving accommodate the shortage by P2P electric power transactions with a consumer B.

### RELATED ART DOCUMENTS

### Patent Documents

[Patent Document 1] Japanese Laid-Open Patent Application No. 2018-033273

[Patent Document 2] Japanese Laid-Open Patent Application No. 2012-010489

[Patent Document 3] Japanese Laid-Open Patent Application No. 2014-127107

However, even if a majority of consumers were able to handle the requests for electric power saving, if a few consumers failed and the power saving as a whole failed, the aggregator cannot obtain the reward from the electric power company, and cannot distribute the reward to the consumers. In this case, a consumer who succeeded in power saving by receiving electric power accommodation from another consumer in order to meet the request for electric power saving, even though not obtaining the reward, may need to make payment to another consumer as the accommodation source for electric power that was accommodated. Such a risk to the consumer may impede smooth operations of electric power transactions made in response to a request for electric power saving.

### SUMMARY

According to an embodiment, a control method controls a transaction of electric power between a first consumer and a second consumer different from the first consumer, wherein the first consumer and the second consumer receives a request for electric power saving from an aggregator. The method is executed on a computer including a memory and a processor. The method includes obtaining a first amount of electric power as an amount of electric power to be purchased by the first consumer; obtaining a second amount of electric power that can be sold by the second consumer; and controlling the transaction of electric power between the first consumer and the second consumer, even in a case where the second amount of electric power is greater than or equal to the first amount of electric power, according to a comparison result between a predicted value of shortage of electric power with respect to a target of electric power saving, and a measured value of the shortage of electric power at the first consumer.

The object and advantages in the embodiment will be realized and attained by means of the elements and combinations particularly pointed out in the claims. It is to be understood that both the foregoing general description and the following detailed description are exemplary and explanatory and are not restrictive of the invention as claimed.

### BRIEF DESCRIPTION OF DRAWING

FIG. 1 is a diagram illustrating an example in which shortage with respect to a request for electric power saving is accommodated by P2P electric power transactions;

FIG. 2 is a diagram for illustrating an outline of an embodiment of the present disclosure;

FIG. 3 is a diagram for illustrating ranges of predicted shortage;

FIG. 4 is a diagram illustrating an example of a system configuration in an embodiment of the present disclosure;

FIG. 5 is a diagram illustrating an example of a hardware configuration of a matching device 10 in an embodiment of the present disclosure;

FIG. 6 is a diagram illustrating an example of a functional configuration of the matching device 10 in an embodiment of the present disclosure;

FIG. 7 is a sequence chart for illustrating an example of processing steps executed by an electric power accommodation system 1, an aggregator device 40, and consumer devices 50;

FIG. 8 is a diagram illustrating an example of a configuration of information on slots;

FIG. 9 is a diagram illustrating an example of prime costs of electric power of consumers;

FIG. 10 is a diagram for illustrating a calculation method of a range of failure prices;

FIG. 11 is a diagram illustrating an example of a record of a range of failure prices;

FIG. 12 is a diagram illustrating an example of a record of predicted shortage;

FIG. 13 is a diagram illustrating examples of records of buy order information;

FIG. 14 is a diagram illustrating examples of records of sell order information;

FIG. 15 is a diagram illustrating examples of records of information on settled purchase;

FIG. 16 is a diagram illustrating an example of a record of information on settled sale;

FIGS. 17A-B are diagrams illustrating examples of records of information on slot end;

FIG. 18 is a diagram illustrating examples of records of agreement information;

FIG. 19 is a flow chart for illustrating an example of processing steps of a process of determining purchase settlement;

FIG. 20 is a flow chart for illustrating an example of processing steps of a process of determining purchase settlement;

FIG. 21 is a diagram illustrating examples of data of buy order information and sell order information loaded into a memory;

FIG. 22 is a flow chart for illustrating an example of processing steps of a process of determining sale settlement;

FIG. 23 is a flow chart for illustrating an example of processing steps of a process of determining priority of sell order data; and

FIG. 24 is a flow chart for illustrating an example of processing steps of a process of settling agreement.

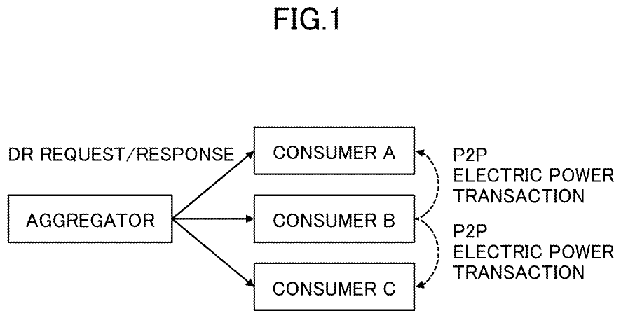

### DESCRIPTION OF EMBODIMENTS

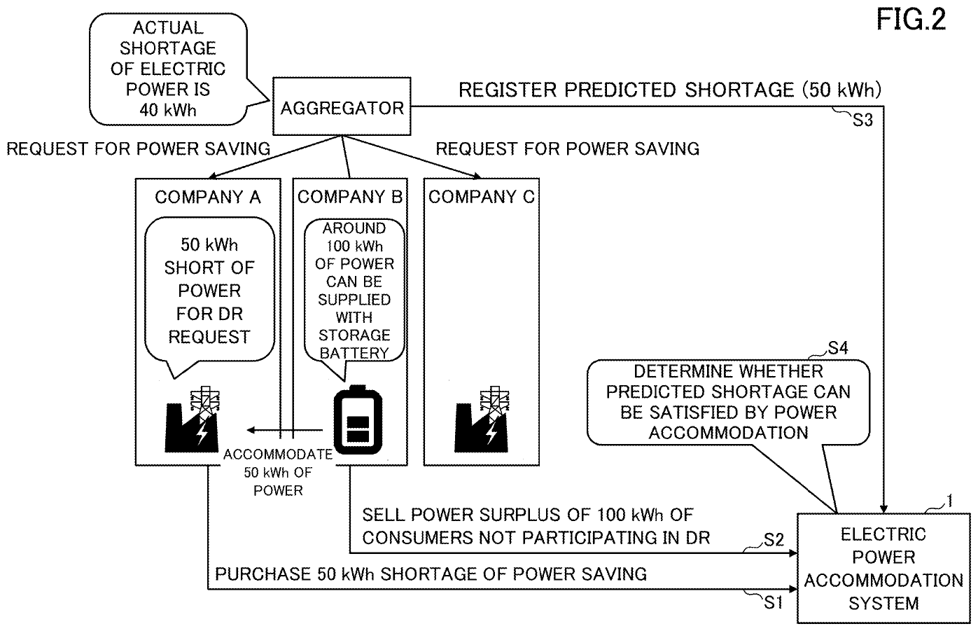

In the following, embodiments according to the present inventive concept will be described based on the drawings. According to one aspect, operations of the electric power transactions in response to a request for electric power saving can be smoothed. FIG. 2 is a diagram for illustrating an outline of an embodiment of the present disclosure.

An aggregator who received a target of electric power saving from an electric power company makes requests for power saving to multiple consumers within reasonable ranges for the respective consumers, to meet as a whole the target of electric power saving presented by the electric power company. Note that the aggregator continuously monitors the consumed electric power of each consumer, and thereby, can grasp power saving within a reasonable range for each consumer. Specifically, in the request for electric power saving for each consumer from the aggregator, an amount of power to be saved is specified based on a normal electric power consumption of the consumer (calculated using a formula called a baseline). In other words, the amount of electric power to be consumed by the consumer is to be less than or equal to an amount obtained by subtracting the power to be saved (hereafter, referred to as the “quota on electric power saving”) from the baseline.

Each consumer (company A and company C in FIG. 2) who received the request for electric power saving from the aggregator, performs power saving to achieve the quota on electric power saving specified in the request for electric power saving. However, in a situation where supply of electric power is tight, there may be a consumer who is unable to achieve power saving corresponding to the quota on electric power saving as expected by the aggregator by the consumer's own effort. Such a consumer (company A in FIG. 2) registers a purchase request (buy order information that will be described later) corresponding to the shortage for the quota on electric power saving (shortage of electric power saving) on the electric power accommodation system 1 (S1). On the other hand, another consumer (company B in FIG. 2) having electric power surplus registers a sale request for the electric power surplus (sell order information that will be described later) on the electric power accommodation system 1 (S2). Note that the electric power accommodation system 1 is a computer system that controls P2P electric power transactions between consumers. In other words, in the present embodiment, in DR transactions, electric power transactions are executed between the consumers (P2P electric power transactions).

Meanwhile, the aggregator predicts an overall shortage of the electric power for the target of electric power saving presented by the electric power company, and registers the predicted value (hereafter, referred to as the “predicted shortage”) on the electric power accommodation system 1 (S3). The predicted shortage is calculated as follows. Note that as power saving is executed in units of periods called slots (normally 30 minutes long), in the following description, attention will be paid to a single slot.

Before starting a slot, within a reasonable range, each consumer is requested for electric power saving. Once the slot has actually started, the aggregator comes to grasp whether the power saving is working as expected (the aggregator comes to grasp whether the power saving is likely to be successful or failed because ordinary power saving is executed during the slot). For example, at constant time intervals, the actual electric power consumption of each consumer as a requested party (i.e., the state of power saving) is observed by the aggregator. As it is difficult for a person to monitor the power saving state of each consumer, normally, artificial intelligence (AI) is introduced to monitor whether the power saving in the slot would become successful or failed, and if it would be failed, an amount of electric power that is required to meet the quota on electric power saving is calculated. Note that success of the power saving means that the target of electric power saving is achieved.

Specifically, as the slot is normally 30 minutes long, for example, based on data during 10 minutes after starting the slot, for the remaining 20 minutes, surplus or shortage with respect to the quota on electric power saving of each consumer is predicted, to calculate a predicted total of the surplus or shortage. The calculation result of the total is registered as the “predicted shortage” on the electric power accommodation system 1.

The electric power accommodation system 1 executes electric power accommodation among the consumers during the rest of the slot (e.g., 15 minutes), to determine whether the predicted shortage registered by the aggregator can be covered (whether there are sale requests that meet purchase requests from the consumers) (S4). In the case where the shortage for the quota on electric power saving is uniform, the amount of electric power that needs to be raised in the remaining 15 minutes, can be easily determined as a cumulative value of the shortage. However, in reality, the shortage for the quota on electric power saving is not uniform; therefore, based on a prediction made by introducing AI, whether the predicted shortage can be satisfied is determined.

In the case where the predicted shortage cannot be covered by the electric power accommodation, the electric power accommodation system 1 suppresses execution of the electric power accommodation. As a result, occurrences of situations such that a consumer who has received electric power accommodation is forced to pay for the cost of accommodated amount without receiving a reward, can be reduced.

On the other hand, even in the case where the predicted shortage can be covered by the electric power accommodation, if the predicted shortage is underestimated with respect to power shortage actually occurred (hereafter, referred to as the “actual power shortage”), namely, if the actual electric power shortage (a measured value of the shortage of the electric power of all consumers who received requests for electric power saving from the aggregator for target of electric power saving presented by the electric power company, namely, the total of the actual shortage of the quota on electric power saving of each consumer who received the request for electric power saving) is greater than the predicted shortage, even though the electric power accommodation is executed, the target of electric power saving cannot be achieved. Note that the actual shortage can be grasped by the aggregator, by monitoring the amount of electric power consumption of each consumer.

Therefore, in the present embodiment, in the case where the predicted shortage predicted by the aggregator is less than the actual shortage, by the aggregator taking back (buying out) the electric power to be sold, the expenses incurred by the consumers are reduced.

However, the electric power under DR (Demand Response) control is traded at a higher price with reference to the reward. If the aggregator buys out accommodated electric power at such a higher price, the expenses imposed on the aggregator increase.

Therefore, the consumer of the accommodation source is requested to present a selling price that is applied in the case where the aggregator fails in the prediction (hereafter, referred to as the “failure price”), and hence, is forced to buy out the accommodated electric power.

When matching a purchase request with a sale request on the electric power accommodation system 1, in matching to be executed until the predicted shortage is covered, matching is executed from a sale request having a lower failure price. Therefore, the consumer who eagerly wants to sell the electric power tends to set a lower failure price than the other consumers, and hence, the expenses imposed on the aggregator can be reduced.

Also, by the market principle, if the prediction success rate of the aggregator increases, the failure price tends to become lower, or conversely, if the prediction success rate decreases, the failure price tends to become higher. However, even when the failure price moves according to the market principle, there is a likelihood that a malicious consumer sets an outrageous failure price.

Therefore, in the present embodiment, a range of failure prices (i.e., the lowest price and the highest price) that can be set in sale requests is specified by the aggregator in advance. The consumer who issues a request sets a failure price within the range. This allows the aggregator to keep the failure price low as long as the prediction success rate is improved, and thereby, motivation to improve the prediction success rate is raised, and the consumer can sell the electric power surplus with a sense of security because the lowest price will not be extremely cheap.

Also, in the present embodiment, by giving the predicted shortage to be predicted by the aggregator as a range rather than a single value, the acceptability for error in the prediction can be retained, and it becomes easier for the aggregator to control the electric power accommodation.

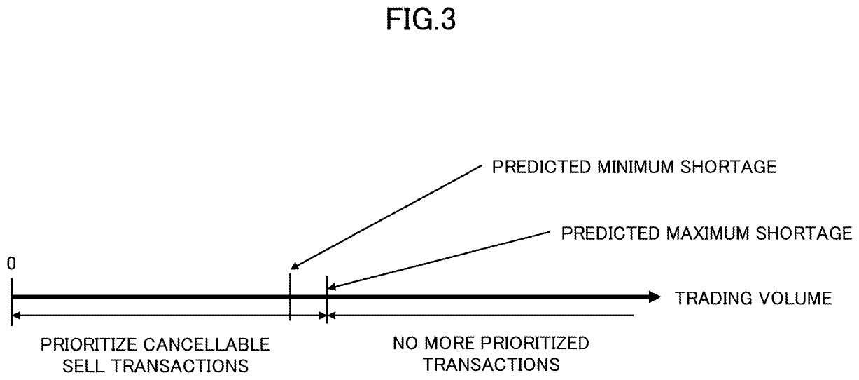

Specifically, in the present embodiment, as illustrated in FIG. 3, the predicted value is provided as a range, and in the case where there are sufficient transactions to cover the predicted shortage described above (hereafter, referred to as the “predicted minimum shortage”), the transactions are matched, and transactions are executed by prioritizing non-cancellable sell orders up to a predicted value that is higher than the predicted shortage by a predetermined amount (hereafter, referred to as the “predicted maximum shortage”, and the predetermined amount can be defined discretionarily). In the case where the trading volume is expected to be greater than the predicted maximum shortage, the trading is executed such that cancellable sell orders are also taken as purchase targets. Note that a non-cancellable sell order is a sell order of electric power obtained by power generation as will be described later. A cancellable sell order is a sell order of apparent surplus of electric power brought by power saving. The electric power generated by power generation incurs the cost of the power generation; therefore, in order to compensate for such a cost, a sell order of such electric power is treated as non-cancellable.

By setting the predicted value as a range, the electric power corresponding to non-cancellable orders can be secured with a certain margin instead of the bare minimum, and the aggregator can reduce failures in DR transactions. Note that in the following, in the case of referring to both the predicted minimum shortage and the predicted maximum shortage, these may be simply referred to as the “predicted shortage”.

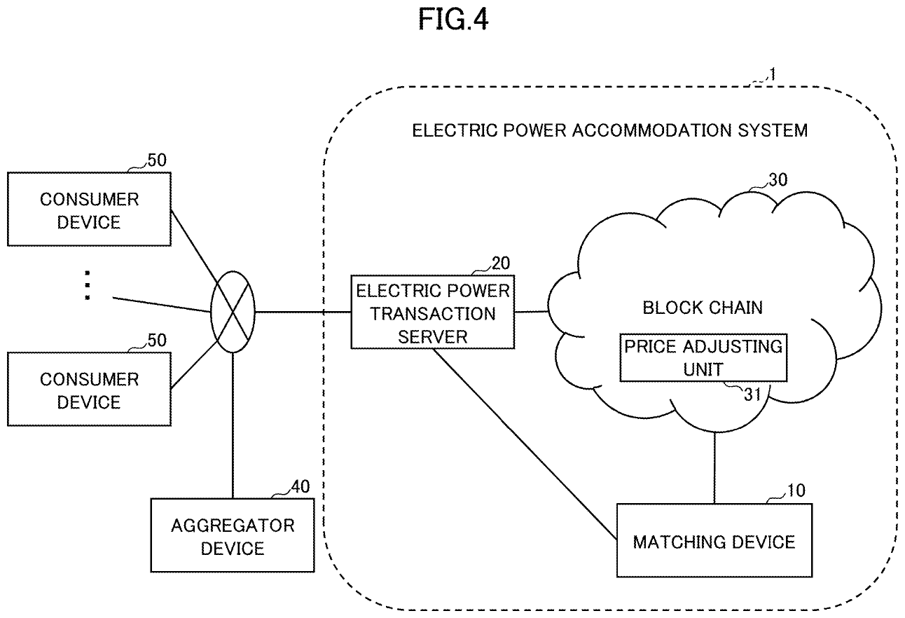

In the following, a system that implements the above will be described specifically. FIG. 4 is a diagram illustrating an example of a system configuration in an embodiment according to the present inventive concept. In FIG. 4, multiple consumer devices 50 are connected to an electric power transaction server 20 via a network such as the Internet. The electric power transaction server 20 is connected to a block chain 30 via a network such as the Internet. A matching device 10 is connected to the block chain 30 and the electric power transaction server 20 via a network such as the Internet. An aggregator device 40 is connected to the respective consumer devices 50 and the electric power transaction server 20 via a network such as the Internet. Note that in FIG. 4, the electric power transaction server 20, the matching device 10, and the block chain 30 constitute the electric power accommodation system 1 described above.

Each of the consumer devices 50 is a computer used by a consumer participating in a DR transaction. As described above, in order to meet a request for electric power saving in a DR transaction, P2P electric power transactions are executed among the consumers. The consumer device 50 of a consumer as a purchaser of electric power in a P2P electric power transaction, transmits buy order information that represents a purchase request of the electric power, to the electric power transaction server 20. The consumer device 50 of a consumer as a seller of electric power, transmits sell order information that represents a sale request of the electric power, to the electric power transaction server 20. Buy order information includes the amount of electric power that needs to be purchased (hereafter, referred to as “purchase amount”). Sell order information includes a minimum amount of electric power that can be sold (hereafter, referred to as the “minimum sale amount”), a maximum amount of electric power that can be sold (hereafter, referred to as the “maximum sale amount”), and a failure price as described above. Note that in the following, in the case of not distinguishing the minimum sale amount and the maximum sale amount, these will be referred to as the “sale amount”.

The electric power transaction server 20 is one or more computers that mediate P2P electric power transactions. In response to receiving buy order information or sell order information transmitted from any consumer device 50, the electric power transaction server 20 records the received information on the block chain 30. The electric power transaction server 20 also records information transmitted from the aggregator device 40 (e.g., the predicted shortage and the like), on the block chain 30.

The matching device 10 matches the buy order information and the sell order information recorded on the block chain 30 (matching between a consumer related to the buy order information and a consumer related to the sell order information), and records information generated in the matching on the block chain 30.

The aggregator device 40 is one or more computers used by the aggregator in DR transactions. For each consumer device 50, the aggregator device 40 transmits a request for electric power saving, calculates a predicted shortage, and compares the predicted shortage with the actual shortage.

The block chain 30 is a distributed ledger in which various items of information on electric power transactions, are recorded. In FIG. 4, the block chain 30 includes a price adjusting unit 31. The price adjusting unit 31 calculates a range of failure prices. Note that the price adjusting unit 31 may be implemented by, for example, a smart contract.

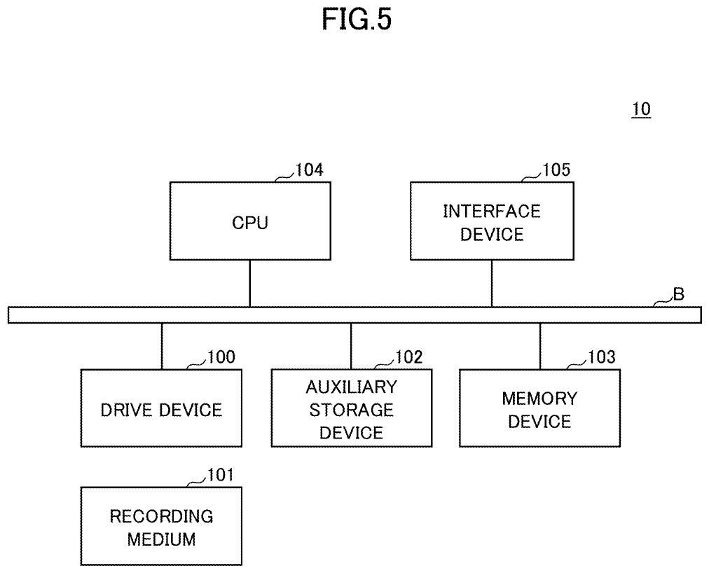

FIG. 5 is a diagram illustrating an example of a hardware configuration of the matching device 10 in the embodiment according to the present inventive concept. The matching device 10 in FIG. 5 includes a drive device 100, an auxiliary storage device 102, a memory device 103, a CPU 104, an interface device 105, and the like, which are connected with each other via a bus B.

A program that implements processing on the matching device 10 is provided with a recording medium 101. Once the recording medium 101 on which the program is stored is set in the drive device 100, the program is installed in the auxiliary storage device 102 from the recording medium 101 via the drive device 100. However, installation of the program does not need to be executed from the recording medium 101 necessarily, and may be downloaded from another computer via the network. The auxiliary storage device 102 stores the installed program, and stores necessary files, data, and the like.

The memory device 103 reads and stores the program from the auxiliary storage device 102 when receiving a start command of the program. The CPU 104 executes functions related to the matching device 10 according to the program stored in the memory device 103. The interface device 105 is used as an interface for connecting to the network.

Note that as an example of the recording medium 101, a portable recording medium such as a CD-ROM, DVD disk, USB memory, or the like may be considered. Also, as an example of the auxiliary storage device 102, an HDD (Hard Disk Drive), flash memory, or the like may be considered. Each of the recording medium 101 and the auxiliary storage device 102 corresponds to a computer-readable recording medium.

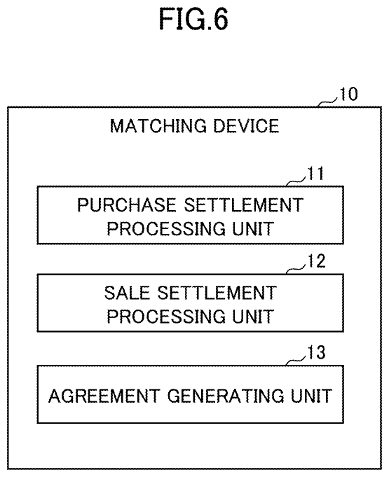

FIG. 6 is a diagram illustrating an example of a functional configuration of the matching device 10 in the embodiment of the present disclosure. In FIG. 6, the matching device 10 includes a purchase settlement processing unit 11, a sale settlement processing unit 12, and an agreement generating unit 13. Each of these units is implemented by one or more programs installed in the matching device 10 that causes the CPU 104 to execute processing.

The purchase settlement processing unit 11 determines whether to purchase electric power related to the purchase amount (amount to be purchased) of buy order information, based on the purchase amount presented in the buy order information, and the sale amount presented in sell order information items. For buy order information that is determined to be purchasable, the purchase settlement processing unit 11 records information representing that the buy order information is purchasable (information on settled purchase that will be described later), on the block chain 30.

After the information on settled purchase has been recorded, based on the purchase amount of the buy order information related to the information on the settled purchase (the buy order information for which the purchase has been settled) and the sale amounts presented in sell order information, the sale settlement processing unit 12 identifies sale information including sale amounts that can be assigned for the purchase amount related to the buy order information. The sale settlement processing unit 12 records the information representing the identified sale information (information on settled sale that will be described later), on the block chain 30.

The agreement generating unit 13 matches the buy order information related to the information on settled purchase, and the sell order information related to the information on settled sale. The agreement generating unit 13 records the agreement information representing the result of the matching on the block chain 30.

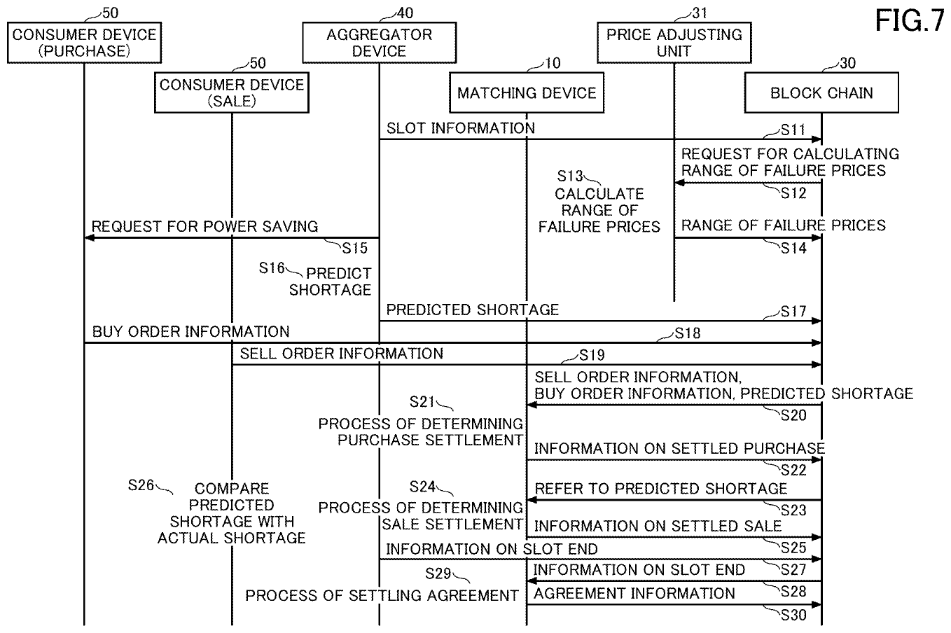

In the following, processing steps executed by the electric power accommodation system 1, the aggregator device 40, and the consumer devices 50 will be described. FIG. 7 is a sequence chart for illustrating an example of processing steps executed by the electric power accommodation system 1, the aggregator device 40, and the consumer devices 50. Note that in FIG. 7, for the sake of convenience, intermediation or relaying executed by the electric power transaction server 20 for various information items stored on the block chain 30 from the aggregator device 40 or the consumer devices 50, is omitted.

In response to receiving a request for electric power saving from an electric power company, the aggregator device 40 records information on slots that splits the power saving period specified in the request for electric power saving (hereafter, referred to as the “information on slots”), on the block chain 30 (S11). Note that generally, a DR transaction is controlled in units of 30-minute slots.

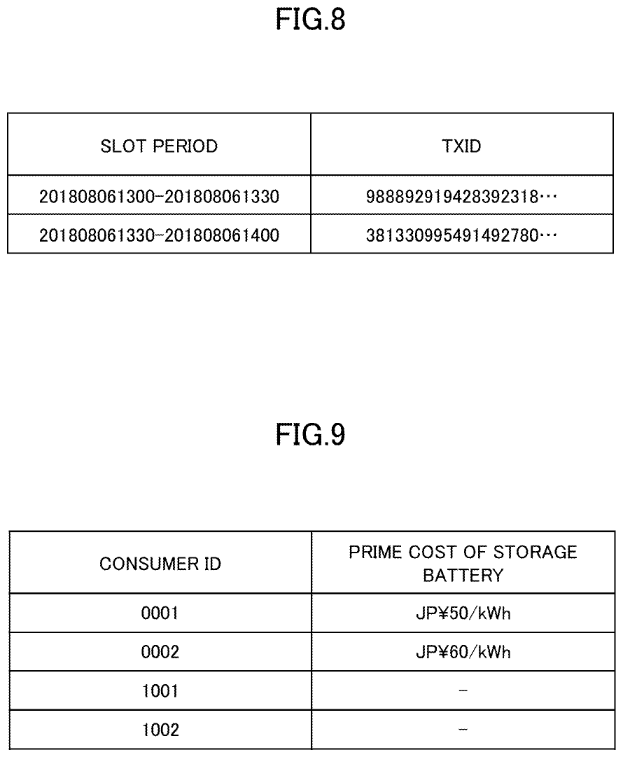

FIG. 8 is a diagram illustrating an example of a configuration of information on slots. As illustrated in FIG. 8, the information on slots for one slot includes fields of slot period and TXID. The slot period is information representing the start time and the end time of the slot. The TXID is an identifier of a transaction on the block chain 30 when the information on slots is registered, and is used as the identification information on an electric power transaction in the slot (hereafter, referred to as the “slot ID”). FIG. 8 illustrates an example in which two records of information on slots are registered. In the following, the description focuses on the first slot in FIG. 8 (hereafter, referred to as the “target slot”). However, a similar process is executed for any slot other than the target slot.

Upon registration of the information on slots, in the block chain 30, the price adjusting unit 31 is requested to calculate a range of failure prices (S12). In response to the request for calculating the range of failure prices, the price adjusting unit 31 calculates a minimum value (hereafter, referred to as the “lowest price”) and a maximum value of the failure prices for the target slot (hereafter, referred to as the “highest price”) (S13).

Specifically, the price adjusting unit 31 calculates the range of failure prices (the lowest price and the highest price) based on the prediction success rate by the aggregator device 40 and the prime cost (JPV/kWh) of electric power of each consumer. Successful prediction means that the predicted minimum shortage predicted by the aggregator device 40 is greater than or equal to the actual shortage. In other words, the predicted minimum shortage predicted by the aggregator device 40 being less than the actual shortage is regarded as failed prediction. This is because, in the case of the predicted minimum shortage being less than the actual shortage, the aggregator is forced to buy out electric power that does not meet the actual shortage. Therefore, the prediction success rate means a probability of the predicted minimum shortage predicted by the aggregator device 40 being greater than or equal to the actual shortage, for slots in the past. Specifically, the prediction success rate is a value obtained by dividing the number of slots whose predicted minimum shortage is greater than or equal to the actual shortage as predicted by the aggregator device 40 from among all slots in the past, by the number of all slots in the past. For those slots whose predicted minimum shortage is greater than or equal to the actual shortage, the aggregator does not need to buy out the electric power, and the request for electric power saving presented by the electric power company can be met by P2P electric power transactions between the consumers. Therefore, for those slots, as will be described later, the block chain 30 records that the prediction of the aggregator was successful as the information on slot end. The price adjusting unit 31 can calculate the prediction success rate by referring to such records. The prediction success rate calculated in this way is overly influenced by the past. Therefore, even if predictions are improved and the prediction accuracy is improved, the benefit is not likely to be clearly apparent in the prediction success rate. Therefore, a prediction success rate can be determined by taking into account the current trend more significantly, for example, by limiting the target slots from all the slots in the past to slots in a certain recent period, or by giving a greater weight to a more recent slot.

Meanwhile, the prime cost of the electric power is provided in advance as a rough estimate value by the consumer who has a possibility to make a request for selling the electric power by measures other than power saving (i.e., the consumer who owns a storage battery), and the value is recorded in advance on the block chain 30 as illustrated in FIG. 9. Strictly speaking, although the prime cost changes as time passes in nature, as it is used for determining a rough estimate value as a whole, rigorousness is not required here. For example, the prime cost may be calculated in advance, based on the purchase cost, the management and operation cost, and the like of the storage battery. At this time, electric power that can be output from the storage battery with respect to electric power stored in the storage battery (e.g., 80%) may be taken into consideration. Note that in FIG. 9, a consumer not having the prime cost registered is a consumer who does not have a storage battery.

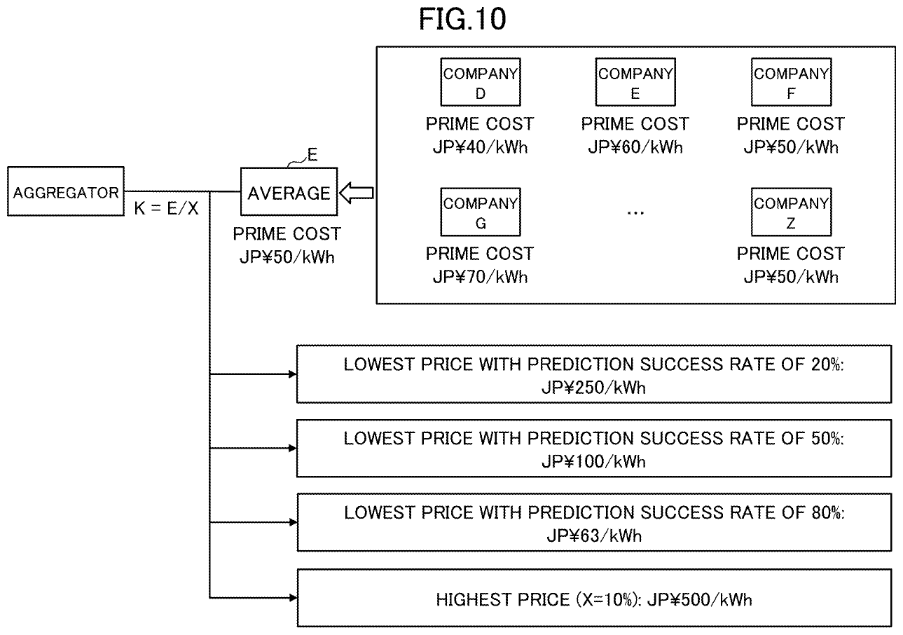

Based on the prediction success rate and the prime cost of the electric power of each consumer described above, the price adjusting unit 31 calculates a range of failure prices as illustrated in FIG. 10.

FIG. 10 is a diagram for illustrating a calculation method of a range of failure prices. As illustrated in FIG. 10, first, the price adjusting unit 31 calculates an average prime cost E of the electric power of the consumers recorded on the block chain 30. In FIG. 10, an example is illustrated where an average E is JP¥50/kWh. The price adjusting unit 31 calculates the lowest price K by applying the average E to the following formula (1):

$$K = E / X \qquad ( 1 )$$

where X is a prediction success rate. The prediction success rate can be calculated by the method described above.

In FIG. 10, calculation results of the lowest price are shown for predicted success rates of 20%, 50%, and 80%. In other words, in the case of the prediction success rate being 20%, the lowest price is JP¥250/kWh. In the case of the prediction success rate being 50%, the lowest price is JP¥100/kWh. In the case of the prediction success rate being 80%, the lowest price is JP¥63/kWh. Assume here that the prediction success rate is 50%. Therefore, the lowest price is JP¥100/kWh.

Also, for example, the price adjusting unit 31 calculates the highest price K by applying the average E to the above formula (1). However, in this case, X is set with a setting value of the prediction success rate that would not incur a loss to a consumer. FIG. 10 illustrates an example where X is set to 10%, and as a result, the highest price is JP¥500/kWh.

Once having calculated the range of failure prices of the target slot, the price adjusting unit 31 records the range of failure prices (the lowest price and the highest price) as the calculation result on the block chain 30 (S14).

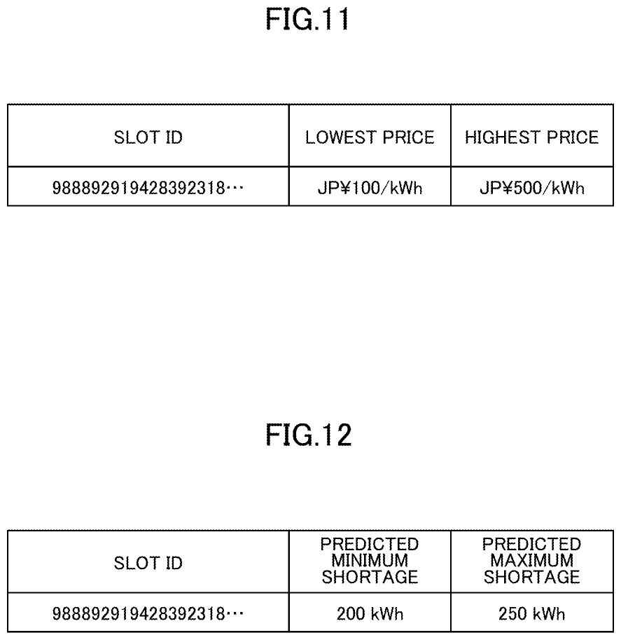

FIG. 11 is a diagram illustrating an example of a record of a range of failure prices. As illustrated in FIG. 11, the lowest price and the highest price are recorded on the block chain 30 in association with the slot ID corresponding to the target slot.

Next, for the target slot, the aggregator device 40 transmits a request for electric power saving including the quota on electric power saving according to the electric power consumption of each consumer, to the corresponding one of the consumer devices 50 (S15). Note that the aggregator device 40 continuously monitor the electric power consumption of each consumer, and thereby, can predict whether the consumer can achieve the power saving to a certain extent. Based on such predictions, the aggregator device 40 requests power saving that can meet the request for electric power saving present by the electric power company this time, to the consumers. Note that all of the consumers may be the targets of the request for electric power saving, or part of the consumers may be the targets of the request for electric power saving.

Next, the aggregator device 40 calculates the predicted value of the shortage of the electric power (predicted shortage) for the target of electric power saving of the target slot at a certain timing in the target slot (S16), and records the predicted shortage on the block chain 30 (S17). At this time, the predicted value is set as the predicted minimum shortage, and the value obtained by adding a predetermined amount to the predicted value is set as the predicted maximum shortage. Note that the timing may be any timing as long as, for example, before actually starting the P2P electric power transaction in the target slot, and before a process of determining sale settlement executed by the matching device 10 that will be described later.

FIG. 12 is a diagram illustrating an example of a record of predicted shortage. As illustrated in FIG. 12, the predicted minimum shortage and the predicted maximum shortage are recorded on the block chain 30 in association with the slot ID corresponding to the target slot.

Thereafter, any consumer who needs to purchase electric power from the other consumers in the target slot, records buy order information representing a purchase request of the electric power in the target slot, on the block chain 30 (S18).

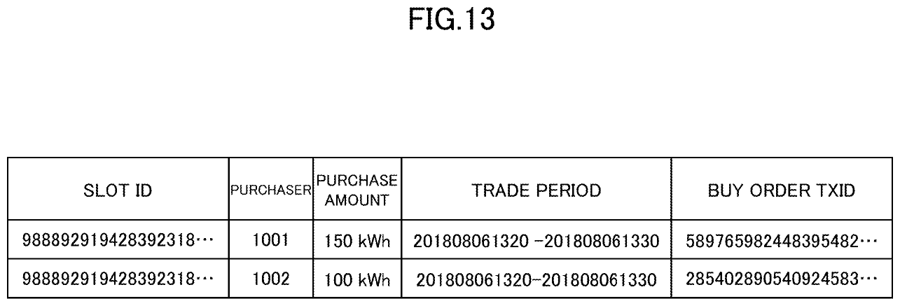

FIG. 13 is a diagram illustrating examples of records of buy order information. In FIG. 13, one row (record) shows one record of buy order information. As illustrated in FIG. 13, one record of buy order information includes fields of slot ID, purchaser, purchase amount, trade period, and buy order TXID.

The slot ID is an ID of a slot corresponding to the buy order information. The purchaser is a consumer ID corresponding to the purchaser related to the buy order information. The purchase amount is an amount of electric power that the purchaser wants to purchase. The trade period is a period of the slot corresponding to the buy order information. The buy order TXID is a transaction ID for the buy order information on the block chain 30.

On the other hand, any consumer who can sell the electric power to the other consumers in the target slot registers sell order information representing a sale request of the electric power in the target slot, on the block chain 30 (519).

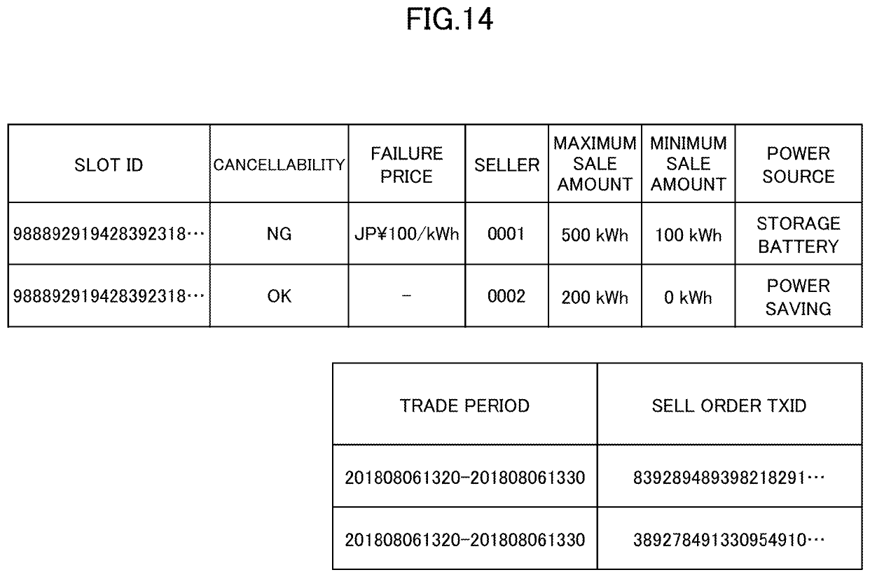

FIG. 14 is a diagram illustrating examples of records of sell order information. In FIG. 14, one row (record) shows one record of sell order information. As illustrated in FIG. 14, one record of sell order information includes fields of slot ID, cancellability, failure price, seller, maximum sale amount, minimum sale amount, power source, trade period, sell order TXID, and the like.

The slot ID is an ID of a slot corresponding to the sell order information. The cancellability represents whether cancellation of the sale of electric power for the sell order information is allowed. Here, the cancellation means cancellation after the sale was settled. Therefore, “non-cancellable” does not mean that the sell order information cannot be cancelled, simply due to the sell order information being recorded on the block chain 30. The failure price is a failure price determined by the consumer as the seller within the range of failure prices (see FIG. 11) registered by the aggregator device 40. The seller is a consumer ID corresponding to the seller related to the sell order information. The maximum sale amount is the maximum amount of electric power that can be sold. The minimum sale amount is the minimum amount of electric power that can be sold. The power source is a power source of the electric power to be sold. As the power source, “storage battery” or “power saving” is specified. Here, “storage battery” indicates that the electric power released from a power source such as a storage battery owned by the seller is the electric power to be sold, whereas “power saving” indicates that surplus of the electric power obtained by power saving by the seller is to be sold. Note that sell order information having “storage battery” as the power source cannot be cancelled. In the case of the power source being “storage battery”, the seller takes the trouble to generate electricity. If the sale of electric power purposefully generated for the P2P electric power transaction is cancelled, the seller incurs a loss. Therefore, sell order information having “storage battery” as the power source cannot be cancelled. Also, if the aggregator device 40 fails in the prediction, sell orders related to non-cancellable sell order information are to be bought out by the aggregator. Therefore, the failure price is specified in the sell order information having “storage battery” as the power source. The trade period is the slot period corresponding to the sell order information. The sell order TXID is a transaction ID for the sell order information in the block chain 30.

Every time detecting that buy order information or sell order information (including the slot ID of the target slot) for the target slot is recorded on the block chain 30, the matching device 10 refers to the predicted shortage of the target slot registered by the aggregator device 40 (S20), to execute a process of determining purchase settlement (S21). The process of determining purchase settlement is a process of determining whether the purchase of the buy order information is settled, for each record of buy order information recorded on the block chain 30 for the target slot. Settlement of the purchase of buy order information means that a definite promise is made for the purchase of the electric power related to the buy order information. Therefore, by having the purchase related to the buy order information settled, the consumer of the registration source of the buy order information can reply to the aggregator that it is possible to meet the request for electric power saving. Note that the process of determining purchase settlement will be described in detail later.

As a result of the process of determining purchase settlement, if there is buy order information for which the purchase has been settled, the matching device 10 records information on the settled purchase representing that the purchase has been settled for the buy order information, on the block chain 30 (S22).

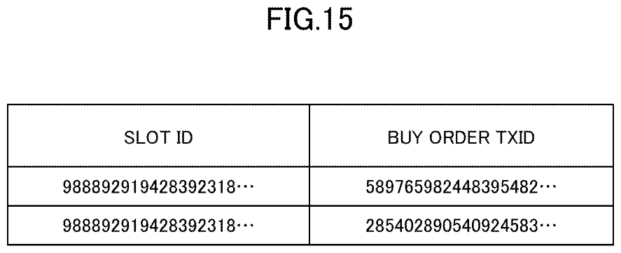

FIG. 15 is a diagram illustrating examples of records of information on settled purchase. In FIG. 15, one row (record) shows one record of information on settled purchase. As illustrated in FIG. 15, one record of information on settled purchase includes fields of slot ID and buy order TXID of buy order information for which the purchase has been settled.

Next, the matching device 10 refers to the predicted shortage of the target slot registered by the aggregator device 40 (S23), to execute a process of determining sale settlement (S24). The process of determining sale settlement is a process of determining sell order information for which the sale is to be settled in the target slot, and does not include matching of buy order information that have been settled with the sell order information (i.e., identification of which seller makes a sale to which purchaser). The process of determining sale settlement may be executed at a timing not delaying the start of the P2P electric power transaction in the target slot. Note that the process of determining sale settlement will be described in detail later.

As a result of the process of determining sale settlement, if there is sell order information for which the sale has been settled, the matching device 10 records the information on the settled sale of the sell order information, representing that the sale has been settled, on the block chain 30 (S25).

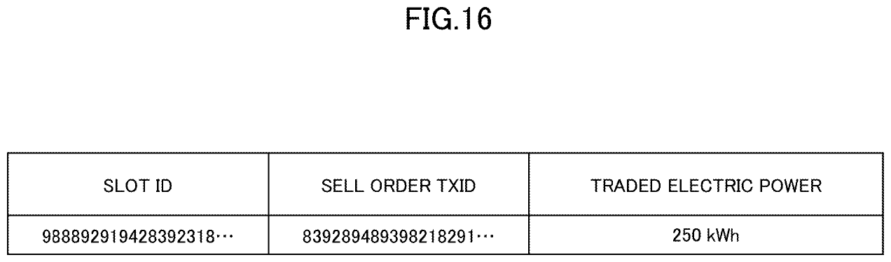

FIG. 16 is a diagram illustrating an example of a record of information on settled sale. In FIG. 16, one row (record) shows one record of information on settled sale. As illustrated in FIG. 16, one record of information on settled sale includes fields of target slot ID, and sell order TXID and traded electric power of the sell order information for which the sale has been settled. The traded electric power is an amount of electric power that has been settled to be sold among the sale amount specified in the sell order information.

Meanwhile, the aggregator device 40 waits for the end of the target slot. Once the target slot ends (i.e., when the end time of the target slot arrives), the aggregator device 40 compares the predicted minimum shortage with the actual shortage for the target slot (S26). Next, according to the comparison result, the aggregator device 40 records the information on the slot end for the target slot, on the block chain 30 (S27). Specifically, if the predicted minimum shortage is greater than or equal to the actual shortage, the aggregator device 40 records the information on the slot end that represents success of the transaction in the target slot (hereafter, referred to as the “success information”), on the block chain 30. On the other hand, if the predicted minimum shortage is less than the actual shortage, the aggregator device 40 records the information on the slot end that represents failure of the transaction in the target slot (hereafter, referred to as the “failure information”), on the block chain 30.

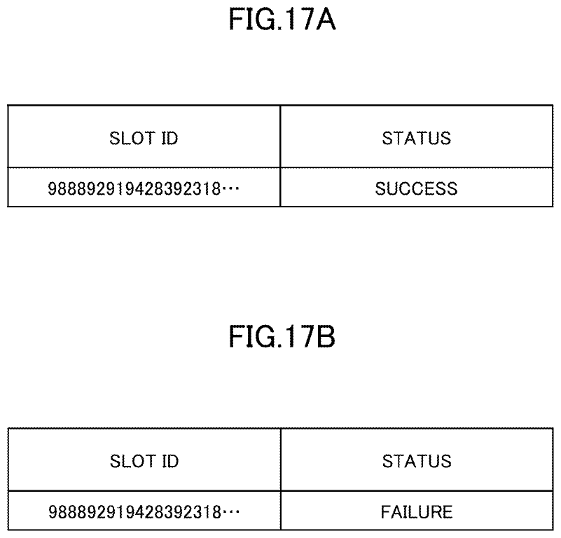

FIGS. 17A-B are diagrams illustrating examples of records of information on slot end. FIG. 17A illustrates success information, whereas FIG. 17B illustrates failure information. In either case, the information on slot end includes fields of slot ID and state. The slot ID is a slot ID of a slot as the target of the information on slot end. The state is information representing whether the transaction in the slot was successful. Note that based on the history of such information on slot end, the price adjusting unit 31 can calculate the prediction success rate.

Once the information on slot end for the target slot is recorded on the block chain 30, the matching device 10 refers to the information on slot end (S28), to execute a process of settling agreement (S29). If the information on slot end is success information, in the process of settling agreement, matching (mapping) is executed between buy order information for which the purchase has been settled with the sell order information for which the sale has been settled, and information indicating the result of matching (hereafter, referred to as the “agreement information”) is recorded on the block chain 30 (S30).

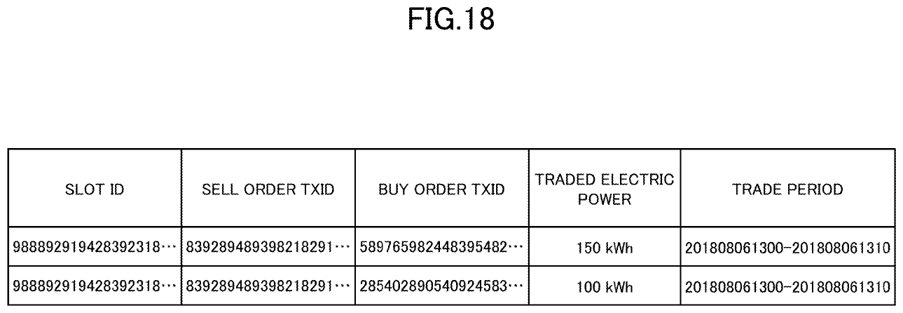

FIG. 18 is a diagram illustrating examples of records of agreement information. In FIG. 18, one row (record) shows one record of agreement information. As illustrated in FIG. 18, one record of agreement information includes fields of slot ID, sell order TXID, buy order TXID, traded electric power, and trade period.

The slot ID is a slot ID of the target slot. The sell order TXID is a sell order TXID of the sell order information. The buy order TXID is a buy order TXID of the buy order information matched with the sell order information. The traded electric power is a traded amount of electric power between the sell order information and the buy order information (the sale amount of the electric power from the sell order information to the buy order information). The trade period is a period of the transaction related to the traded amount (i.e., the period of time of the target slot).

If the information on slot end is success information, the P2P electric power transaction is executed according to the agreement information recorded at Step S30.

On the other hand, if the information on slot end is failure information, among the sell order information for which sales have been settled, for non-cancellable sell order information, in the process of settling agreement, agreement information to be sold to the aggregator is recorded on the block chain 30 (S30). Such agreement information may have the identification information on the aggregator recorded, for example, in the field of “buy order TXID” in the agreement information illustrated in FIG. 18.

In this case, during the target slot, among the sell order information for which sales have been settled, the aggregator buys out the traded electric power for the sell order information that is non-cancellable. Specifically, by referring to the information on settled sale related to the target slot ID (see FIG. 16), the sell order TXID and traded electric power of the sell order information for which the sale has been settled, can be identified. Whether the sell order information is non-cancellable can be determined by referring to the sell order information including the sell order TXID (see FIG. 14).

In this way, in the case where the aggregator fails in prediction, even if the consumer is to receive the electric power accommodation, the consumer can be paid by the aggregator for the cost of the electric power accommodation. As a result, the consumer is no longer burdened with the expenses related to the electric power accommodation in a state of missing reception of the reward of the DR transaction, and can receive the electric power accommodation with a sense of security in the case of receiving the electric power accommodation.

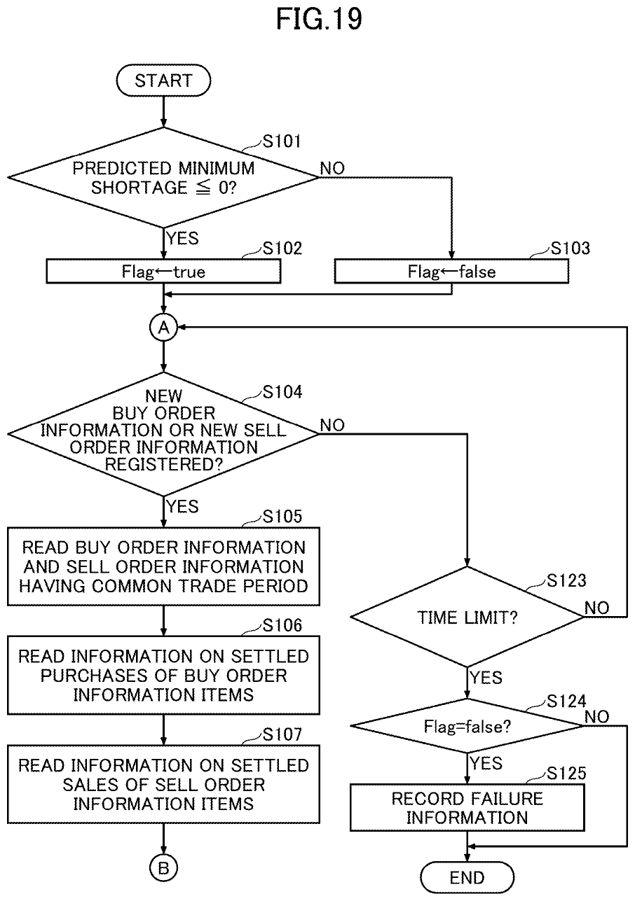

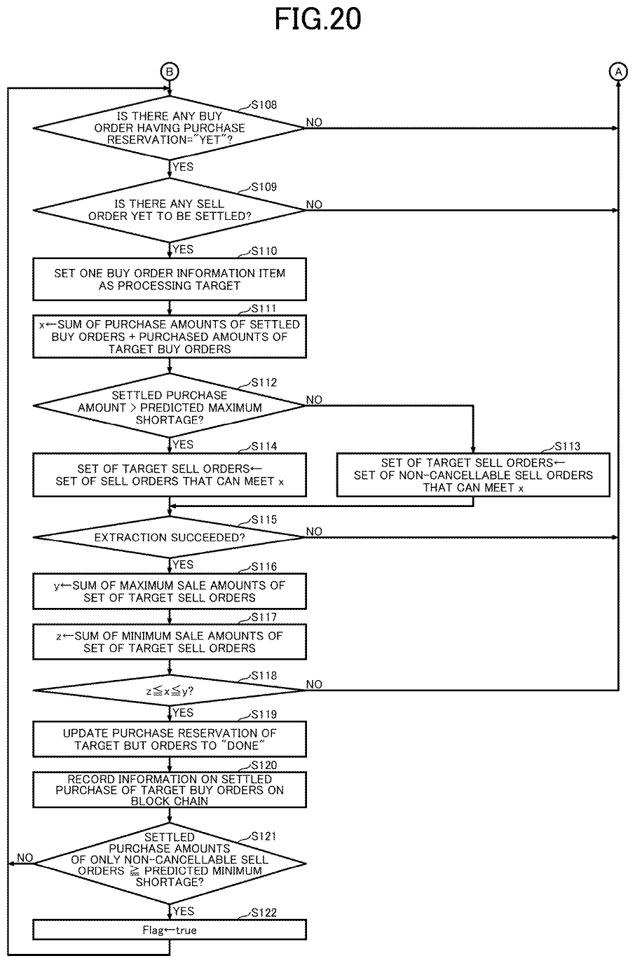

Next, Step S21 will be described in detail. FIGS. 19 and 20 constitute a flow chart for illustrating an example of processing steps of the process of determining purchase settlement.

Once the process of determining purchase settlement starts, the purchase settlement processing unit 11 determines whether the predicted minimum shortage recorded by the aggregator device 40 on the block chain 30 is less than or equal to 0 (S101). If the predicted minimum shortage is less than or equal to 0 (YES at S101), the purchase settlement processing unit 11 sets a variable Flag to true (S102). On the other hand, if the predicted minimum shortage is greater than 0 (NO at S101), the purchase settlement processing unit 11 initializes the variable Flag with false (S103). Note that the variable Flag is a Boolean variable for storing whether a P2P electric power transaction can be executed in the target slot. Here, true indicates that the transaction is possible, whereas false indicates that the transaction is not possible. However, the determination on whether a P2P electric power transaction can be executed based on the variable Flag, is made after the end of the process of determining purchase settlement. This is because, if the variable Flag is initialized with false, there is a likelihood that the value is changed to “true” later.

Next, the purchase settlement processing unit 11 waits for recording (registration) of new buy order information or new sell order information on the block chain 30 (S104). Once new buy order information or new sell order information is recorded on the block chain 30 (YES at S104), the purchase settlement processing unit 11 reads from the block chain 30 buy order information and sell order information having the common trade period (i.e., having the common slot ID) with the new buy order information or the new sell order information (S105).

Next, the purchase settlement processing unit 11 reads from the block chain 30 information on settled purchases corresponding to the buy order information read at Step S105 (S106).

Next, the purchase settlement processing unit 11 reads from the block chain 30 information on settled sales corresponding to the sell order information read at Step S105 (S107).

Note that here, as for the buy order information illustrated in FIG. 13 and the sell order information illustrated in FIG. 14, the recording order on the block chain 30 is as follows: sell order information (1)→buy order information (1)→sell order information (2)→buy order information (2). Here, the sell order information (1) refers to the first sell order information in FIG. 14. The sell order information (2) refers to the second sell order information in FIG. 14. The buy order information (1) refers to the first buy order information in FIG. 13. The buy order information (2) refers to the second buy order information in FIG. 13.

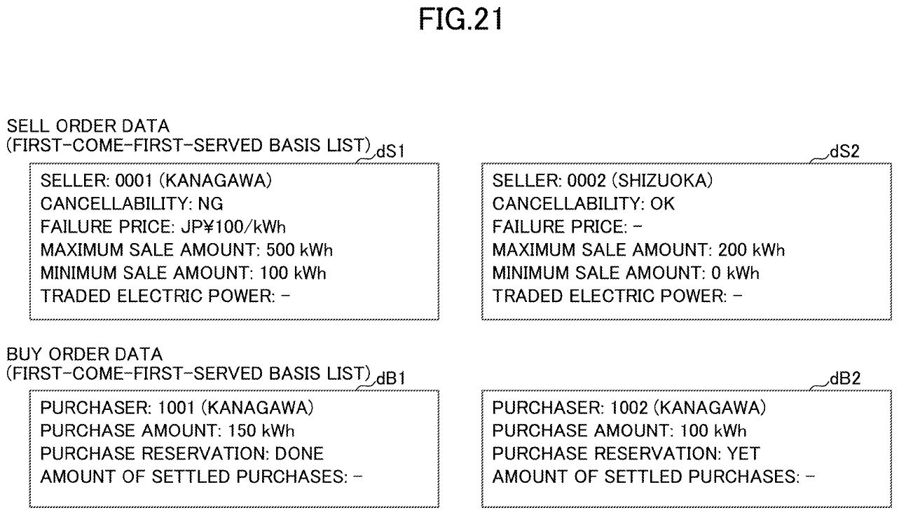

Further, assume here that a situation where Steps S105 and thereafter have been executed in response to the buy order information (2) being registered on the block chain 30. In other words, assume a situation where the buy order information (1) in FIG. 13, and the sell order information (1) and the sell order information (2) in FIG. 14 have already been registered on the block chain 30, and the buy order information (2) is newly registered on the block chain 30. Therefore, the buy order information (1) has already been settled, whereas the sell order information (1) and the sell order information (2) are not settled. In other words, information on settled purchase corresponding to the buy order information (1) has already been registered on the block chain 30, whereas information on settled sale corresponding to the sell order information (1) and the sell order information (2) is not registered on the block chain 30. Therefore, based on the information read at from Steps S105 to S107, the purchase settlement processing unit 11 generates data as illustrated in FIG. 21 in the memory device 103.

FIG. 21 is a diagram illustrating examples of data of buy order information and sell order information loaded into the memory. In FIG. 21, sell order data dS1 corresponds to the sell order information (1), and sell order data dS2 corresponds to the sell order information (2). Also, buy order data dB1 corresponds to the buy order information (1), and buy order data dB2 corresponds to the buy order information (2).

The sell order data includes sell order information and “traded electric power”. The “traded electric power” is “traded electric power” in information on settled sale corresponding to the sell order information. Here, as the sale has not been settled (the information on settled sale is not recorded on the block chain 30) for either of the sell order information item (1) or (2), for both the sell order data items dS1 and dS2, the value of the traded electric power is empty.

The buy order data includes buy order information, “purchase reservation”, and “amount of settled purchases”. Here, “the purchase reservation” is an item indicating whether the buy order information has been settled. “DONE” indicates settlement already made, and “YET” indicates settlement yet to be made. Here, the buy order information (1) has been settled (the information on settled sale is recorded on the block chain 30); therefore, the purchase reservation of the buy order data dB1 is “DONE”. The “amount of settled purchases” is an item in which the purchase amount of the electric power from the seller is recorded if one or more sellers as the sellers of the electric power have been settled (matched).

Note that items of “seller” of the sell order data and items of “purchaser” of the buy order data illustrated in FIG. 21 show the respective locations of the sellers and the purchasers in parentheses. The location may be retrieved, for example, from attribute information on each consumer stored in the electric power transaction server 20. Note that in the present embodiment, for the sake of convenience, the location is expressed by the prefecture; however, other formats such as the municipality, the latitude and longitude, or the like may be used.

Next, the purchase settlement processing unit 11 determines whether there is buy order data having the value “YET” in the purchase reservation (S108 in FIG. 20). If there is no corresponding buy order data (NO at S108), the process returns to Step S104. If there is corresponding buy order data (hereafter, referred to as the “data group of candidate buy orders”) (YES at S108), the purchase settlement processing unit 11 determines whether there is sell order data not settled (i.e., having no value recorded on “traded electric power”) (S109). If there is no corresponding sell order data (NO at S109), the process returns to Step S104. If there is corresponding sell order data (hereafter, referred to as the “data group of candidate sell orders”) (YES at S109), the process proceeds to Step S110.

At Step S110, the purchase settlement processing unit 11 selects one item of buy order data from among the data group of candidate buy orders as the processing target on the first-come-first-served basis. According to the example in FIG. 21, the buy order data dB2 is set as the processing target (hereafter, referred to as the “target buy order data”).

Next, the purchase settlement processing unit 11 sets the variable x with a result of adding the purchase amount of the target buy order data to the total of the buy amount of the buy order data (hereafter, referred to as the “settled purchase amount”) with which the purchase reservation is completed (the value of the purchase reservation is “DONE”) (S111). According to the example in FIG. 21, the purchase amount of the buy order data dB1 for which the purchase reservation has been made is 150 kWh, and the purchase amount of the target buy order data (the buy order data dB2) is 100 kWh. Therefore, x is set with 150 kWh+100 kWh=250 kWh.

Next, the purchase settlement processing unit 11 determines whether the settled purchase amount is greater than the predicted maximum shortage for the target slot (S112). If the settled purchase amount is less than or equal to the predicted maximum shortage (NO at S112), the purchase settlement processing unit 11 extracts sell order data that has the value “NA” in “cancellability”, and can meet the purchase amount indicated by x, from among the data group of candidate sell orders on the first-come-first-served basis (S113). In the following, a set of one or more sell order data items extracted will be referred to as the “set of target sell orders”. Specifically, the purchase settlement processing unit 11 extracts non-cancellable sell order data from among the data group of candidate sell orders on the first-come-first-served basis, until the total of the maximum sale amount becomes greater than or equal to x. In the example in FIG. 21, the maximum sale amount (500 kWh) of the first sell order data dS1 is greater than or equal to x (250 kWh). Therefore, the sell order data dS1 becomes an element of the set of target sell orders.

On the other hand, if the settled purchase amount is greater than the predicted maximum shortage for the target slot (YES at S112), the purchase settlement processing unit 11 extracts sell order data that can meet the purchase amount indicated by x, from among the data group of candidate sell orders on the first-come-first-served basis (S114). In the following, a set of one or more extracted sell order data items will be referred to as the “set of target sell orders”. Specifically, the purchase settlement processing unit 11 extracts the sell order data from among the data group of candidate sell orders on the first-come-first-served basis, until the total of the maximum sale amount becomes greater than or equal to x. In other words, at Step S114, the set of target sell orders is extracted regardless of the cancellability.

If a set of target sell orders (i.e., sell order data that can meet the purchase amount indicated by x) cannot be extracted at Step S113 or S114 (NO at S115), the process returns to Step S104. If a set of target sell orders is extracted (YES at S115), the purchase settlement processing unit 11 sets the variable y with the total of the maximum sale amount of the set of target sell orders included in the set of target sell orders (S116). In the example in FIG. 21, 500 kWh as the maximum sale amount of the sell order data dS1 is set to the variable y.

Next, the purchase settlement processing unit 11 sets the variable z with the total of the minimum sale amount of the set of target sell orders included in the set of target sell orders (S117). In the example in FIG. 21, 100 kWh as the minimum sale amount of the sell order data dS1 is set to the variable z.

Next, the purchase settlement processing unit 11 determines whether a condition of the value of x being greater than or equal to z and less than or equal to y (hereafter, referred to as the “condition of settling purchase”) is satisfied (S118). If the condition of settling purchase is not satisfied (NO at S118), the process returns to Step S104. If the condition of settling purchase is satisfied (YES at S118), the purchase settlement processing unit 11 updates the purchase reservation of the target buy order data from “YET” to “DONE” (S119). Next, the purchase settlement processing unit 11 records the information on settled purchase corresponding to the target buy order data, on the block chain 30 (S120).

In the example in FIG. 21, the value of x (250 kWh) is greater than or equal to z (100 kWh) and less than or equal to y (500 kWh). Therefore, the information on settled purchase corresponding to buy order data dB2 is recorded on the block chain 30.

Next, the purchase settlement processing unit 11 determines whether the settled purchase amount becomes greater than or equal to the predicted minimum shortage only with non-cancellable sell orders (S121). A settled purchase amount only with non-cancellable sell orders is a settled purchase in the case where “cancellability” of all the sell order data included in the set of target sell orders is “NA”. Therefore, the determination condition at Step S121 is that the “cancellability” of all the sell order data included in the set of target sell orders is “NA”, and the settled purchase amount is greater than or equal to the predicted minimum shortage.

If the determination condition at Step S121 is satisfied (YES at S121), the purchase settlement processing unit 11 sets the FLAG to true, and returns to Step S108 (S122). On the other hand, if the determination condition at Step S121 is not satisfied (NO at S121), without setting the Flag to true, the process returns to Step S108. Once the process returns to Step S108, the purchase settlement processing unit 11 executes Steps S108 and thereafter for buy order data of the buy order information registered next to the buy order information on the target buy order data.

Steps S104 and thereafter are executed until the time limit of the process of determining purchase settlement arrives (S123 in FIG. 19). The time limit of the process of determining purchase settlement may set to be, for example, the start of a process of determining sale settlement. Once the time limit of the process of determining purchase settlement arrives (YES at S123), the purchase settlement processing unit 11 determines whether the value of the variable Flag is false (S124). If the value of Flag is false (YES at S124), the purchase settlement processing unit 11 records the information on slot end indicating that the P2P electric power transaction failed for the target slot (FIG. 17B) on the block chain 30 (S125).

Following Step S125 or NO at Step S124, the process of determining purchase settlement ends.

Note that the electric power transaction server 20 regularly confirms whether there is registration of new information on settled purchase on the block chain 30. When new information on settled purchase is registered, the electric power transaction server 20 transmits a notice of purchase settlement to the consumer device 50 as the sender of the buy order information corresponding to the information on settled purchase. By receiving the notice of settlement, the consumer of the consumer device 50 can respond to the request for electric power saving (DR response).

Note that if failure information is recorded (if Step S125 is executed), Steps S23 and thereafter in FIG. 7 are not executed. Therefore, in this case, the P2P electric power transaction is not executed (the P2P electric power transaction is suppressed).

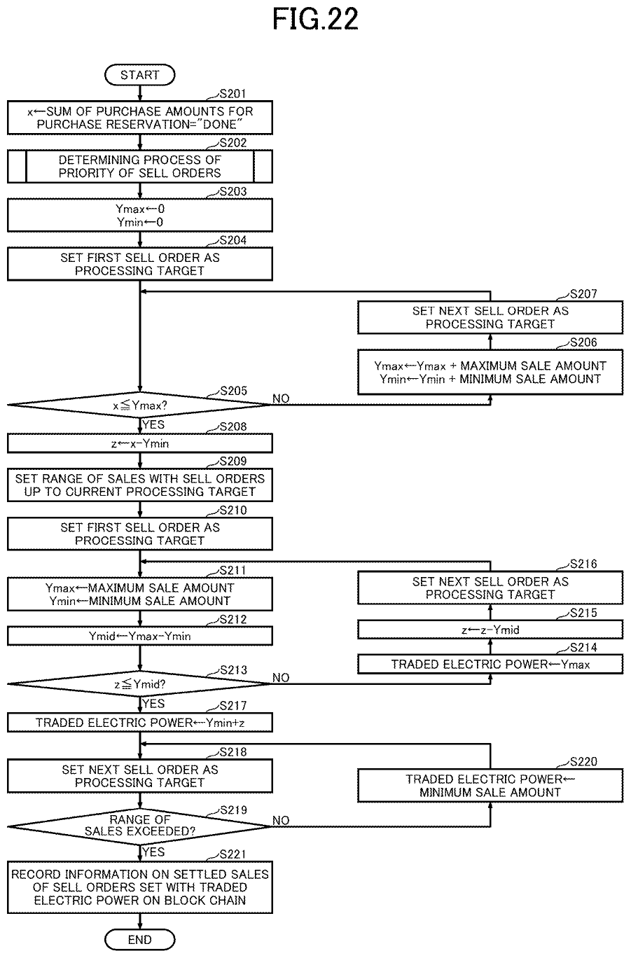

Next, Step S24 in FIG. 7 will be described in detail. FIG. 22 is a flow chart for illustrating an example of processing steps of the process of determining sale settlement. The processing step in FIG. 22 is executed, for example, before a predetermined time at which a P2P electric power transaction in the target slot is started (the start time of the P2P electric power transaction—β). In other words, the processing step in FIG. 22 may be executed at a timing not delaying the start of the transaction.

At Step S201, the sale settlement processing unit 12 sets the variable x with the total of buy order data having the purchase reservation “DONE” among the group of buy order data related to the group of buy order information on the target slot (hereafter, referred to as the “total amount of buy orders”).

Next, the sale settlement processing unit 12 executes a determining process of priority for the group of sell order data of the target slot (hereafter, referred to as the “data group of candidate sell orders”) (S202). In the determining process of the priority, among non-cancellable sell order data, for the data group of candidate sell orders, a list of the sell order data (hereafter, referred to as the “list of candidate sell orders”) in which the arrangement order is changed into an order prioritizing sell order data relatively low failure prices.

At Steps S203 and thereafter, the sale settlement processing unit 12 executes a process of identifying sell order data assigned for the traded electric power for the total amount x of buy orders, and the respective traded electric power of the sell order data.

At Step S203, the sale settlement processing unit 12 sets each of the variables Ymax and Ymin to 0. The variable Ymax is a variable for storing the total of the maximum sale amount of the sell order data to which the traded electric power is assigned with respect to the total amount x of buy orders. The variable Ymin is a variable for storing the total of the minimum sale amount of the sell order data to which the traded electric power is assigned with respect to the total amount x of buy orders.

Next, the sale settlement processing unit 12 sets the first sell order (hereafter, referred to as the “target sell order data”) in the list of candidate sell orders as the processing target (S204).

Next, the sale settlement processing unit 12 determines whether Ymax is greater than or equal to x (S205). In other words, it is determined whether the total of the maximum sale amount is greater than or equal to total amount x of buy orders. If Ymax is less than x (NO at S205), the sale settlement processing unit 12 sets Ymax with a result of adding Ymax and the maximum sale amount of the target sell order data, and sets Ymin with a result of adding Ymin and the minimum sale amount of the target sell order data (S206). Next, the sale settlement processing unit 12 sets the target sell order data with the next sell order data of the target sell order data in the list of candidate sell orders, and repeats Steps S205 and thereafter (S207).

Next, the sale settlement processing unit 12 sets the variable z with a result of subtracting Ymin from the total amount of buy orders x (S208). In other words, a purchase amount short of the total amount x of buy orders, obtained as a result of assigning the minimum sale amount of each sell order data item, is set to z (hereafter, referred to as the “unassigned amount z”).

Next, the sale settlement processing unit 12 sets sell orders up to the current target sell order data as a range for assigning traded electric power being greater than or equal to the minimum sale amount (hereafter, referred to as the “range of sales R”) (S209).

At the following Steps S210 to S217, the sale settlement processing unit 12 executes a process of assigning (distributing) the unassigned amount z, for each sell order data item included within the range of sales R.

At Step S210, the sale settlement processing unit 12 sets the first sell order in the list of candidate sell orders as the processing target (hereafter, referred to as the “target sell order data”). Next, the sale settlement processing unit 12 sets Ymax with the maximum sale amount of the target sell order data, and the minimum sale amount of the target sell order data to Ymin (S211). Next, the sale settlement processing unit 12 sets the variable Ymid with a result of subtracting Ymin from Ymax (S212). The variable Ymid is a sale amount corresponding to the unassigned portion in the target sell order data.

Next, the sale settlement processing unit 12 determines whether Ymid is greater than or equal to the unassigned amount z (S213). If Ymid is less than the unassigned amount z (NO at S213), the sale settlement processing unit 12 sets the traded electric power of the target sell order data to Ymax (S214). In other words, the maximum sale amount of the target sell order data is set as the traded electric power of the target sell order data. Next, the sale settlement processing unit 12 sets the unassigned amount z with a result of subtracting Ymid from the unassigned amount z (S215). Next, the sale settlement processing unit 12 sets the target sell order data with sell order data next to the target sell order data in the list of candidate sell orders, and repeats Steps S211 and thereafter (S216). On the other hand, if Ymid is greater than or equal to the unassigned amount z (YES at S213), the sale settlement processing unit 12 sets the traded electric power of the target sell order data with a result of adding Ymin and the unassigned amount z (S217).

At the following Steps S218 to S220, the sale settlement processing unit 12 executes a process of setting the minimum sale amount for the traded electric power for each of the other sell order data items within the range of sales R.

At Step S218, the sale settlement processing unit 12 sets the target sell order data with sell order data next to the target sell order data in the list of candidate sell order. Next, the sale settlement processing unit 12 determines whether the target sell order data exceeds the range of sales R. If the target sell order data does not exceed the range of sales R (NO at S219), the sale settlement processing unit 12 sets the traded electric power of the target sell order data with the minimum sale amount of the target sell order data, and returns to Step S218 (S220).

If the target sell order data exceeds the range of sales R (YES at S219), the sale settlement processing unit 12 records information on settled sale corresponding to the sell order data in which the traded electric power has been set with a value in the list of candidate sell orders, on the block chain 30 (S221).

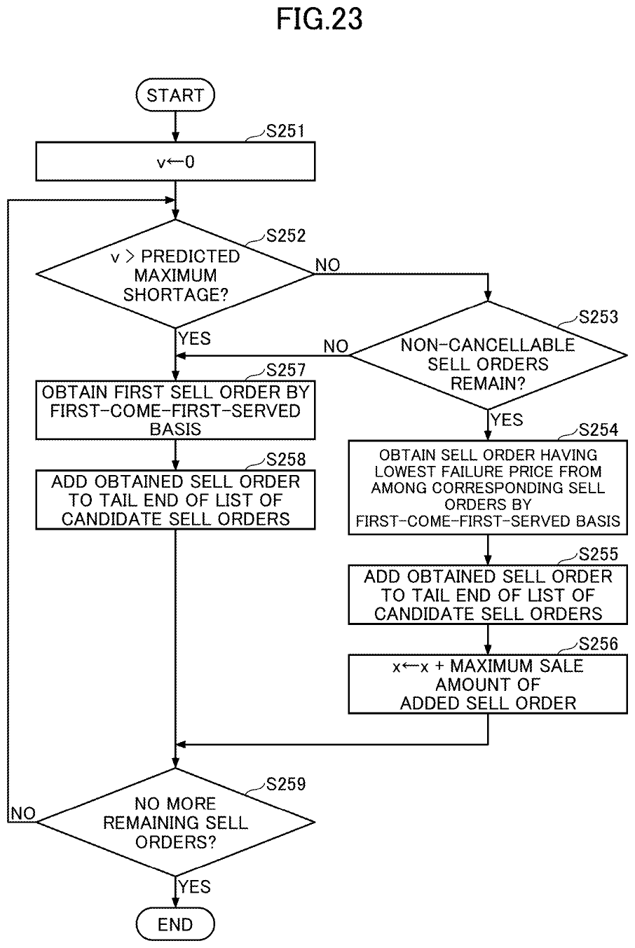

Next, Step S202 will be described in detail. FIG. 23 is a flow chart for illustrating an example of processing steps of the process of determining priority of sell order data. At the start of the processing steps in FIG. 23, the list of candidate sell orders is empty.

At Step S251, the sale settlement processing unit 12 sets the variable v to 0. The variable v is a variable for storing the total value of the maximum sale amount of the sell order data (sell order information) added to the list of candidate sell orders.

Next, the sale settlement processing unit 12 compares the value of the variable v with the predicted maximum shortage (S252). If the value of the variable v is less than or equal to the predicted maximum shortage (NO at S252), the sale settlement processing unit 12 determines whether there is sell order data having “NA” as “cancellability” in the data group of candidate sell orders (S253). If there is one or more corresponding sell order data items (YES at S253), the sale settlement processing unit 12 obtains one sell order data item having the lowest “failure price” from among the corresponding sell order data items from among the data group of candidate sell orders on the first-come-first-served basis (S254). At this time, the target sell order data is removed from among the data group of candidate sell orders.

Next, the sale settlement processing unit 12 adds the target sell order data to the tail end of the list of candidate sell orders (S255). Next, the sale settlement processing unit 12 adds the value of “maximum sale amount” of the target sell order data to the variable v (S256). Next, the process proceeds to Step S259.

On the other hand, if the value of the variable v is greater than the predicted maximum shortage (YES at S252), the sale settlement processing unit 12 obtains one sell order data item (hereafter, referred to as the “target sell order data”) that comes first on the first-come-first-served basis in the data group of candidate sell orders, from among the data group of candidate sell orders (S257). At this time, the target sell order data is removed from among the data group of candidate sell orders. Next, the sale settlement processing unit 12 adds the target sell order data to the tail end of the list of candidate sell orders (S258). Next, the process proceeds to Step S259.

At Step S259, the sale settlement processing unit 12 determines whether one or more sell order data items remain in the data group of candidate sell orders. If one or more the sell order data items remain in the data group of candidate sell orders (NO at S259), Steps S252 and thereafter are repeated. If no sell order data remains in the data group of candidate sell orders (YES at S259), the process in FIG. 23 ends.

According to the processing steps in FIG. 23, until v becomes greater than the predicted maximum shortage, among non-cancellable sell order data items, sell order data items having relatively low failure prices are prioritized to be added to the list of candidate sell orders; and after v has become greater than the predicted maximum shortage, regardless of the cancellability, a preceding sell order data item on the first-come-first-served basis is prioritized to be added to the list of candidate sell orders.

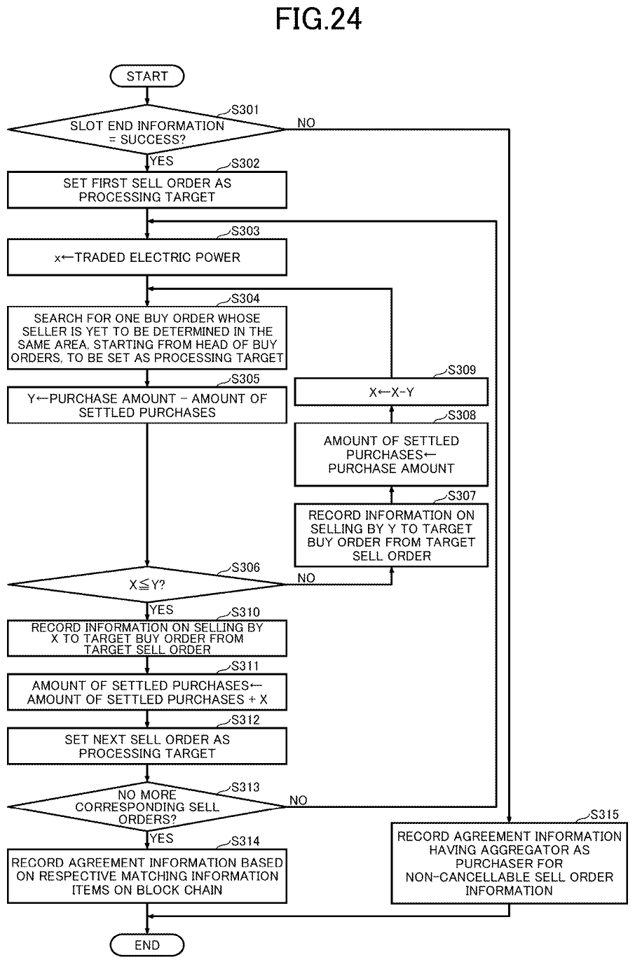

Next, Step S29 in FIG. 7 will be described in detail. FIG. 24 is a flow chart for illustrating an example of processing steps of the process of settling agreement.

At Step S301, the agreement generating unit 13 determines whether the information on slot end obtained by the agreement generating unit 13 at Step S28 in FIG. 7 is success information. If the information on slot end is success information (YES at S301), the agreement generating unit 13 sets the first sell order data item as the processing target (hereafter, referred to as the “target sell order data”), from among the sell order data items included within the range of sales R in the list of candidate sell orders.

Next, the agreement generating unit 13 sets the traded electric power of the target sell order data to the variable X (S303). The variable X is a variable for storing the remaining amount of the traded electric power of the target sell order data (hereafter, referred to as the “remaining amount to be traded”).

Next, from among a group of buy order data having the purchase reservation “DONE” (hereafter, referred to as the “data group of candidate buy orders”), the agreement generating unit 13 searches for buy order data whose location of the purchaser is the same as the location of the seller of the target sell order data, and the amount of settled purchases is short of the purchase amount (less than the purchase amount), and sets the first buy order data item from among the corresponding buy order data as the processing target (S304). Note that if there is no corresponding buy order data, the first buy order data item from among the buy order data that are closest to the location of the seller of the target sell order data is set as the processing target. In the following, the buy order data item set as the processing target will be referred to as the “target buy order data”.

Next, the agreement generating unit 13 sets the variable Y with a result of subtracting the amount of settled purchases of the target buy order data from the purchase amount of the target buy order data (S305). In other words, the variable Y is a variable for storing the shortage for the purchase amount for the target buy order data.

Next, the agreement generating unit 13 compares the remaining amount to be traded X with the shortage Y (S306). If the remaining amount to be traded X is greater than the shortage Y (NO at S306), the agreement generating unit 13 records the matching information that represents selling of electric power by the amount Y from the target sell order data to the target buy order data (assigning the consumer related to the target buy order data as the purchaser of electric power by the amount Y), on the memory device 103 (S307). Next, the agreement generating unit 13 sets the value of the purchase amount of the target buy order data for the amount of settled purchases of the target buy order data (S308). As a result, all sellers have been settled for the target buy order data. Next, the agreement generating unit 13 X sets the remaining amount to be traded X with a result of subtracting the shortage Y from the remaining amount to be traded X (S309), and repeats Steps S304 and thereafter.

On the other hand, at Step S306, if the remaining amount to be traded X is less than or equal to the shortage Y (YES at S306), the agreement generating unit 13 records the matching information that represents selling of electric power by the amount X from the target sell order data to the target buy order data, on the memory device 103 (S310). Next, the agreement generating unit 13 sets the amount of settled purchases of the target buy order data with a result of adding the remaining amount to be traded X and the amount of settled purchases of the target buy order data (S311). Next, the agreement generating unit 13 sets sell order data next to the target sell order data within the range of sales R as the processing target (S312). If there is corresponding sell order data (NO at S312), the sell order data is set as the target sell order data, and Steps S302 and thereafter are repeated.

In other words, at Steps S302 to S313, for each sell order data item, based on the geographical proximity between the seller and the purchaser, buy order data corresponding to the purchaser is determined. However, for each buy order data item, sell order data corresponding to the seller may be determined.

For all the sell order data within the range of sales R, once the steps up to Step S312 are executed on the first-come-first-served basis (YES at S313), the agreement generating unit 13 records the agreement information based on each matching information item recorded at Step S307 or S310, on the block chain 30 (S314).

On the other hand, if the information on slot end obtained at Step S28 in FIG. 7 is failure information (NO at S301), among the sell order information for which sales have been settled, for non-cancellable sell order information, the agreement generating unit 13 executes controlling to suppress P2P electric power transactions between the consumers, by recording agreement information to be sold to the aggregator on the block chain 30 (S315). In other words, the agreement generating unit 13 sets the aggregator as the purchaser of the traded electric power of the information on settled sale related to the sell order information.

Note that between the matched consumers, the electric power may not be transmitted in practice, and only monetary transactions may be executed. In other words, it is sufficient to realize the reduction of power by the DR transactions as a whole, the seller simply needs to reduce the power by the sale amount (traded electric power).

As described above, according to present embodiment, even in the case where there is an amount of electric power available for sale that is greater than or equal to the amount of electric power to be purchased by a consumer who received a request for electric power saving, in the case of the predicted shortage being less than the actual shortage, the P2P electric power transactions between the consumers are controlled to be suppressed. Therefore, a P2P electric power transaction from which the reward would not be obtained can be avoided. As a result, operations of the electric power transactions in response to a request for electric power saving can be smoothed.

Also, in the case of the predicted shortage being less than the actual shortage, the amount of electric power related to non-cancellable sell orders is purchased by the aggregator. As a result, the expenses imposed on the consumer can be reduced, and operations of the electric power transactions in response to a request for electric power saving can be smoothed.

Also, in the process of determining sale settlement, sell order information having a relatively low failure price is prioritized. This means that, upon matching buy order information with sell order information, the sell order information having a relatively low failure price is prioritized (i.e., a relatively low failure price tends to make the sale more successful). Therefore, incentive to setting a lower failure price can be given to a consumer selling electric power. As a result, a steep rise in the purchase price to be paid by the aggregator can be curbed.

Note that in the present embodiment, the matching device 10 is an example of an information processing device. The purchase settlement processing unit 11 exemplifies operations executed by a processor as obtaining a first amount of electric power, and obtaining a second amount of electric power. The agreement generating unit 13 exemplifies operations executed by a processor as controlling and assigning.

As described above, embodiments according to the present inventive concept have been described in detail; note that the present inventive concept is not limited to such specific embodiments, and various modifications and alterations can be made within the scope of the subject matters of the present inventive concept described in the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device that controls a transaction of electric power between a first consumer and a second consumer different from the first consumer, each of the first consumer and the second consumer receiving a request for electric power saving from an aggregator, the information processing device comprising:
a memory; and
a processor configured to execute
obtaining a first amount of electric power as an amount of electric power to be purchased by the first consumer;
obtaining a second amount of electric power that can be sold by the second consumer; and
controlling the transaction of electric power between the first consumer and the second consumer, even in a case where the second amount of electric power is greater than or equal to the first amount of electric power, according to a comparison result between a predicted value of shortage of electric power with respect to a target of electric power saving, and a measured value of the shortage of electric power at the first consumer.

2. The information processing device as claimed in claim 1, wherein the processor suppresses the transaction of electric power between the first consumer and the second consumers, in a case where the predicted value is less than the measured value.

3. An information processing device that controls transactions of electric power between a plurality of first consumers and a plurality of second consumers different from the first consumers, each of the first consumers and the second consumers receiving a request for electric power saving from an aggregator, the information processing device comprising:
a memory; and
a processor configured to execute
obtaining a first amount of electric power as an amount of electric power to be purchased by each of the first consumers;
obtaining a second amount of electric power that can be sold by each of the second consumers; and
assigning said each of the first consumers as a purchaser of the second amounts of electric power, or assigning the aggregator as the purchaser of the second amounts of electric power, according to a comparison result between a predicted value of shortage of electric power with respect to a target of electric power saving, and a measured value of the shortage of electric power at the first consumers.

4. The information processing device as claimed in claim 3, wherein upon executing the obtaining, the processor obtains a second amount of electric power that can be sold by each of the second consumers; and
wherein upon executing the assigning, the processor assigns said each of the first consumers as the purchaser of the second amounts of electric power, by prioritizing a second amount of electric power of a second consumer offering a relatively low selling price, in a case where the predicted value is less than the measured value.

5. The information processing device as claimed in claim 3, wherein upon executing the assigning, the processor assigns said each of the first consumers as the purchaser of the second amount of electric power, by prioritizing the second amount of electric power generated by power generation, up to a quota exceeding the predicted value by a predetermined amount.

6. A non-transitory computer-readable recording medium having computer-readable instructions stored thereon, which when executed, cause a computer including a memory and a processor to execute a process of controlling transactions of electric power between a plurality of first consumers and a plurality of second consumers different from the first consumers, each of the first consumers and the second consumers receiving a request for electric power saving from an aggregator, the process comprising:
obtaining a first amount of electric power as an amount of electric power to be purchased by each of the first consumers;
obtaining a second amount of electric power that can be sold by each of the second consumers; and
assigning said each of the first consumers as a purchaser of the second amounts of electric power, or assigning the aggregator as the purchaser of the second amounts of electric power, according to a comparison result between a predicted value of shortage of electric power with respect to a target of electric power saving, and a measured value of the shortage of electric power at the first consumers.

7. The non-transitory computer-readable recording medium as claimed in claim 6, wherein the obtaining of the second amounts of electric power further obtains a selling price for said each of the second consumers, and
wherein the assigning assigns said each of the first consumers as the purchaser of the second amounts of electric power, by prioritizing a second amount of electric power of a second consumer offering a relatively low selling price, in a case where the predicted value is less than the measured value.

8. The non-transitory computer-readable recording medium as claimed in claim 6, wherein the assigning assigns said each of the first consumers as the purchaser of the second amounts of electric power, by prioritizing a second amount of electric power generated by power generation, up to a quota exceeding the predicted value by a predetermined amount.
